(19) United States
(12) Patent Application Publication
(10) Pub. No.: US 2023/0418722 A1
(43) Pub. Date: Dec. 28, 2023

(54) System, Device, and Method for Continuous Modelling to Simiulate Test Results

(71) Applicant: The Toronto-Dominion Bank, Toronto (CA)

(72) Inventors: Kevin AIRD, Toronto (CA); Aayush KATHURIA, Brampton (CA); Periyakaruppan SUBBUNARAYANAN, Mississauga (CA)

(73) Assignee: The Toronto-Dominion Bank, Toronto, ON (CA)

(21) Appl. No.: 17/808,456

(22) Filed: Jun. 23, 2022

(51) Int. Cl. G06F 11/34; G06F 11/36

(52) U.S. Cl. CPC G06F 11/3457; G06F 11/3664

(57) ABSTRACT

The system, method, and device for simulating application performance prior to conducting performance testing is disclosed. The illustrative method includes obtaining results of a preliminary simulation, and processing the obtained results from the preliminary simulation, with a profiling tool, and generate a software model based on an output of the profiling tool. A workload model and a hardware model are configured to account for a desired scenario. A performance model is defined using the software model, the workload model, and the hardware model, and prior to testing the application, the performance model is used to simulate performance of the application in the desired scenario.

### TECHNICAL FIELD

The following relates generally to testing of applications, and more specifically to simulating application behavior during a performance test before or otherwise without conducting such performance tests.

### BACKGROUND

Application testing can require a large amount of potentially expensive resources. For example, application testing can include various skilled personnel (e.g., test planning professionals, project management professionals, etc.) and resources (e.g., testing scripts, computing environments and resources, etc.). These resources can be difficult to coordinate, as they operate potentially asynchronously and in different physical locations with different availability.

It can also be difficult to understand how a proposed change to an application, or a new application, will perform before investing the resources to implement a performance test. For example, it can be difficult to accurately predict application behavior relative to performance standards prior to creating a significant portion of a performance test. Therefore, it can be difficult to, beforehand, determine a likelihood that any resources committed to finish the application or the change, or to perform a performance test are not wasted.

Similarly, it can be difficult to predict how changes to: (1) the proposed application, (2) the infrastructure expected to implement the proposed application, or (3) the expected performance test, will impact the performance of the proposed application.

Frameworks which help to assess how a proposed application, or a change to an existing application, is likely to perform (e.g., perform during a performance test, or more generally) before committing resources are desirable. Frameworks which enable faster, less expensive, more robust, and/or more accurate evaluations or simulations are also desirable.

### BRIEF DESCRIPTION OF THE DRAWINGS

Embodiments will now be described with reference to the appended drawings wherein:

FIG. 1 is a schematic diagram of an example computing environment.

FIG. 2 is a schematic diagram of an example configuration for simulating application performance without conducting performance testing.

FIG. 3 is a block diagram of an example configuration of a simulation module.

FIGS. 4A and 4B are each a flow diagram of an example of computer executable instructions for performing manipulations to or with a simulation module.

FIG. 5 is a flow diagram of an example of computer executable instructions for generating at least a component of a performance model used by a simulation module.

FIG. 6 is a schematic diagram of an example framework for automated modelling.

FIG. 7 is a flow diagram of another example of computer executable instructions for simulating application performance without conducting performance testing.

FIG. 8 is a block diagram of an example device.

FIG. 9 is a block diagram of an example configuration of an enterprise system.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

Throughout this disclosure, reference will be made to a “simulation”, which term is used to denote a process analogous to a preliminary assessment of the performance of an application. As used herein, the term simulation may refer to various forms of evaluating the application. The term is not limited to evaluations wherein the application is simulated with only the most rudimentary framework or is simulated in only the most simplified environment. The term simulation, and derivatives thereof, is understood to include a variety of different configurations and frameworks for assessing the likely performance of an application, with this disclosure including illustrative examples. Simulations are understood to not be limited to simulations of the efficiency of an application and can assess an application's likely performance including its interaction with hardware, directly or indirectly, utilized because of the running of the application. For example, an example application may complete a particular task by relying upon certain communication hardware and related firmware to communicate with a server to retrieve certain information. The simulation of the application can incorporate or simulate the performance of the application as a whole, including the application's interaction with the communication hardware (e.g., does the application use the hardware efficiently?) and reliance thereon (e.g., does the application expect unrealistic performance from the communication hardware to complete certain functionality within a certain timeframe?).

The disclosed system and method include obtaining results from a software profiling tool and generating a software model of the proposed application or change based on an output of the software profiling tool. A performance model of the application is defined using the software model, a workload model, and a hardware model. The performance model is used to generate simulation results to assess the performance of the proposed application prior to executing a performance test. The described performance model can, beforehand, or relatively early in the application design process, assess whether to perform the proposed application will satisfy required simulation evaluation parameters before a performance test is engineered and executed.

By implementing the performance model in components, changes to the expected workload and hardware can be incorporated into the model without undue effort. For example, in response to cloud computing cost increases, a new application can be proposed to reduce the reliance on the cloud computing system (i.e., to lower costs). A performance model can be created for the proposed application to simulate whether the application is likely to succeed in its objective. Similar processes can be applied to new builds of an application (i.e., changes to an application), where the software model is updated for each build to determine whether the build is in a worthwhile state.

In addition, simulations as described herein can allow for a relatively rapid assessment of various scenarios without a corresponding commitment of resources. For example, many simulations can be performed to determine which hardware or workload configuration is most likely to succeed for the proposed application or change, or to predict performance of the application in different scenarios. In another example, simulations can reveal that it is unrealistic that the chosen performance criteria will be met without expending the resources to implement the application. Continuing the example, the simulation may allow for the rejection of certain builds that exceed variance thresholds.

In one aspect, a device for simulating application performance prior to conducting performance testing is disclosed. The device includes a processor, a communications module coupled to the processor, and a memory coupled to the processor. The memory stores computer executable instructions that when executed by the processor cause the processor to obtain results of a preliminary simulation of an application in a development environment. The processor processes the obtained results from the preliminary simulation, with a profiling tool, and generates a software model based on an output of the profiling tool. The processor configures a workload model and a hardware model to account for a desired scenario, and defines a performance model using the software model, the workload model, and the hardware model. The processor, prior to testing the application, uses the performance model to simulate performance of the application in the desired scenario.

In example embodiments, the processor continuously updates the performance model to account for changes in the workload model and the hardware model.

In example embodiments, the processor formats the obtained results prior to generating the performance model.

In example embodiments, the profiling tool comprises a third-party software profiling tool.

In example embodiments, the workload model at least in part represents an expected peak and average workload of the desired scenario.

In example embodiments, the profiling tool models the application at least in part by code profiling.

In example embodiments, the processor initiates the preliminary simulation in response to determining the application requires simulation. In example embodiments, the processor determines whether the application requires simulation by determining whether important applications are impacted by the application.

In example embodiments, the processor transmits results of the application simulation to a dashboard.

In example embodiments, the processor assigns one or more resources in response to the results of the application simulation.

In example embodiments, the development environment comprises a scaled down development environment.

In another aspect, a method for simulating application performance prior to conducting performance testing is disclosed. The method includes obtaining results of a preliminary simulation of an application in a development environment. The method includes processing the obtained results from the preliminary simulation, with a profiling tool, and generating a software model based on an output of the profiling tool. The method includes configuring a workload model and a hardware model to account for a desired scenario, and defining a performance model using the software model, the workload model, and the hardware model. The method includes, prior to testing the application, using the performance model to simulate performance of the application in the desired scenario.

In example embodiments, the method includes continuously updating the performance model to account for changes in the workload model and the hardware model.

In example embodiments, the method includes formatting the obtained results prior to generating the performance model.

In example embodiments, the profiling tool comprises a third-party software profiling tool.

In example embodiments, the workload model at least in part represents an expected peak and average workload of the desired scenario.

In example embodiments, the profiling tool models the application at least in part by code profiling.

In example embodiments, the method includes initiating the preliminary simulation in response to determining the application requires simulation.

In example embodiments, the method includes assigning one or more resources in response to the results of the application simulation.

In yet another aspect, a non-transitory computer readable medium for simulating application performance prior to performance testing is disclosed. The computer readable medium includes computer executable instructions for obtaining results of a preliminary simulation of an application in a development environment. The instructions are for processing the obtained results from the preliminary simulation, with a profiling tool, and generating a software model based on an output of the profiling tool. The instructions are for configuring a workload model and a hardware model to account for a desired scenario, and defining a performance model using the software model, the workload model, and the hardware model. The instructions are for, prior to testing the application, using the performance model to simulate performance of the application in the desired scenario.

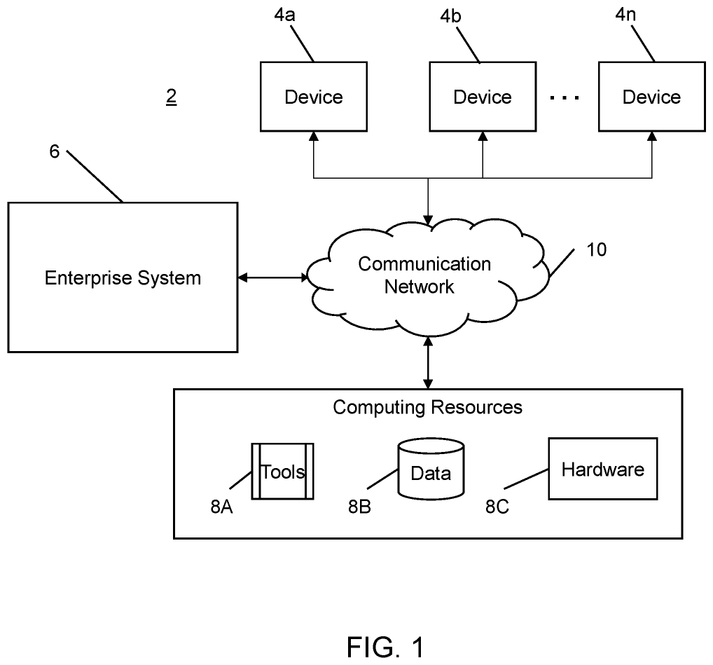

Referring now to FIG. 1, an exemplary computing environment 2 is illustrated. In the example embodiment shown, the computing environment 2 includes one or more devices 4 (shown as devices 4a, 4b, . . . 4n), enterprise system 6, and computing resources 8 (shown individually as tool(s) 8A, database(s) 8B, and hardware 8C, referred to hereinafter in the singular for ease of reference). Each of these components can be connected by a communications network 10 to one or more other components of the computing environment 2. In at least some example embodiments, all of the components shown in FIG. 1 are within the enterprise system 6.

The one or more devices 4 (hereinafter referred to in the singular, for ease of reference) can be a device 4 operated by a client, or another party which is not controlled by the enterprise system 6, or at least one device 4 of a plurality of devices can be internal to the enterprise system 6. For example, the enterprise system 6 can contract a third-party to develop an application for the enterprise via a device 4a but perform simulations internally via device 4b to determine whether the current state of the testing is likely to meet proprietary or regulatory requirements. Similarly, an organization that develops an application may outsource testing, but perform simulations internally.

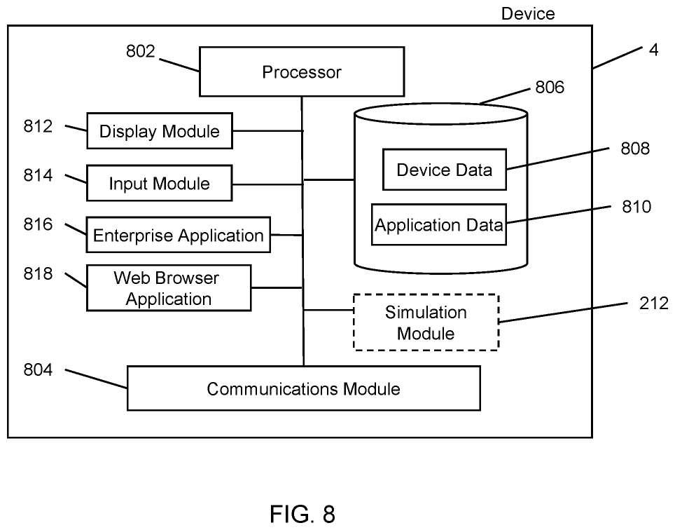

The device 4 can access the information within the enterprise system 6 in a variety of ways. For example, the device 4 can access the enterprise system 6 via a web-based application (e.g., web browser application 818 of FIG. 8), a dedicated application (e.g., enterprise application 816 of FIG. 8). Access can require the provisioning of various types of credentials (e.g., login credentials, two factor authentication, etc.). In example embodiments, each device 4 can be provided with a unique amount (and/or with a particular type) of access. For example, the device 4a internal to the organization can be provided with a greater degree of access as compared to the external device 4b.

Devices 4 can include, but are not limited to, one or more of a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication networks such as the communication network 10 shown by way of example in FIG. 1.

The computing resources 8 include resources that can service the enterprise system 6 and that are stored or managed by a party other than proprietor of the enterprise system 6 (hereinafter referred to in the alternative as the external party). For example, the computing resources 8 can include cloud-based storage services (e.g., database 8B) and other cloud-based resources available to the enterprise system 6. In at least some example embodiments, the computing resources 8 include a tool 8A developed or hosted by the external party. For example, the tool 8A can include modelling tools such as Palladio's™ Component Model. The computing resources 8 can also include hardware resources 8C, such as access to processing capability by remote server devices (e.g., cloud computing), and so forth.

Communication network 10 may include a telephone network, cellular, and/or data communication network to connect different types of devices. For example, the communication network 10 may include a private or public switched telephone network (PSTN), mobile network (e.g., code division multiple access (CDMA) network, global system for mobile communications (GSM) network, and/or any 3G, 4G, or 5G wireless carrier network, etc.), Wi-Fi or other similar wireless network, and a private and/or public wide area network (e.g., the Internet). The communication network 10 may not be required to provide connectivity within the enterprise system 6 wherein an internal network provides the necessary communications infrastructure.

The computing environment 2 can also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public and private keys in a PKI), and perform other cryptographic operations that are required or desired for particular applications carried out by the enterprise system 6.

The cryptographic server may be used to protect data within the computing environment 2 (including data stored in database 8B) by way of encryption for data protection, digital signatures or message digests for data integrity, and by using digital certificates to authenticate the identity of the users and entity devices with which the enterprise system 6, the computing resources 8, or the device 4 communicates to inhibit data breaches by adversaries. It can be appreciated that various cryptographic mechanisms and protocols, as are known in the art, can be chosen and implemented to suit the constraints and requirements of the particular enterprise system 6, the computing resources 8, and/or device 4.

The enterprise system 6 can be understood to encompass the whole of the enterprise, a subset of a wider enterprise system (not shown), such as a system serving a subsidiary, or a system for a particular branch or team of the enterprise (e.g., a software simulation division of the enterprise). In at least one example embodiment, the enterprise system 6 is a financial institution system (e.g., a commercial bank) that provides financial services accounts to users and processes financial transactions associated with those financial service accounts. Such a financial institution system may provide to its customers various browser-based and mobile applications, e.g., for mobile banking, mobile investing, mortgage management, etc.

The enterprise system 6 can request to, receive a request to, or itself implement a simulation to assess performance of an application or application change.

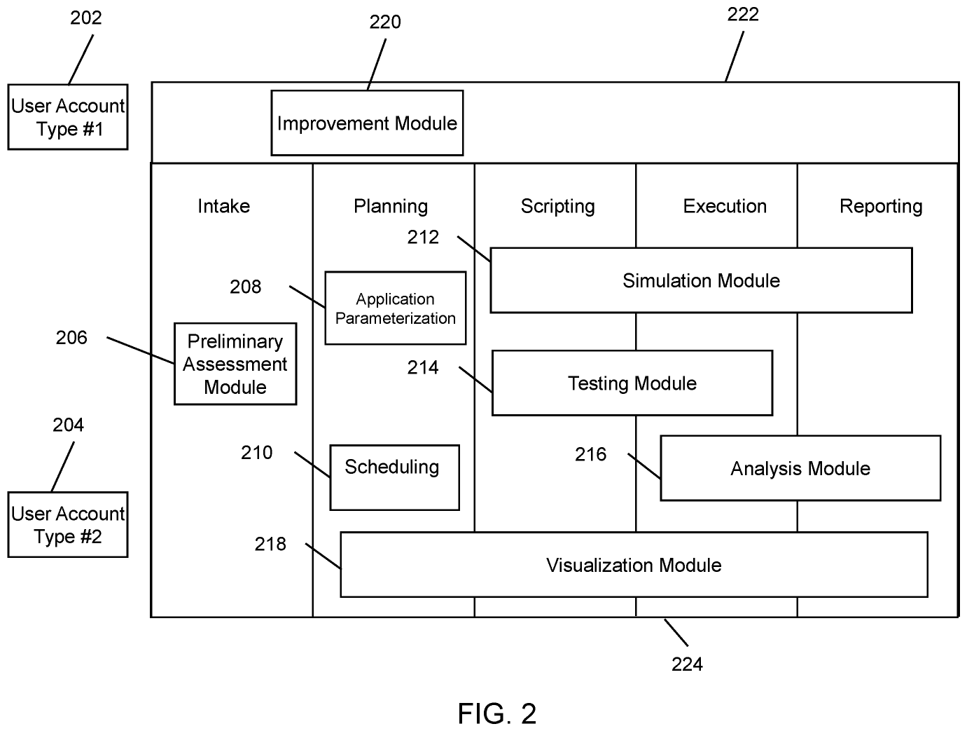

Referring now to FIG. 2, an example configuration for simulating application performance is shown. To enhance visual clarity, connecting lines between the shown elements are omitted; however, examples of such connectivity are described herein.

In the shown embodiment, the configuration contemplates two different applications or environments for different user types: a first environment 222 for a first user account type 202 (e.g., based on login credentials of the device 4), and a second environment 224 for a second user account type 204. In at least some example embodiments, the first user account type 202 is an account associated with a performance engineer or simulation evaluator, and the second user account type 204 is an account type associated with a member of a simulation team or a project delivery team.

At block 206, an application, or a change to an application is proposed (e.g., the intake phase). Various members of a team sharing the same user account type 202 may determine whether performance testing may be required. For example, performance testing may be required where the aforementioned application or change is expected to impact or interact with (1) a minimum number of other applications or tools (i.e., the application or changes have a complexity that warrants testing), or (2) existing applications or tools which are of an elevated importance (e.g., the changes impact a ledger storing login credentials, and changes that impact the ledger have low tolerance for error), etc.

Where performance testing is required, the remaining phases of the configuration may be completed, as denoted by the remaining blocks. Moreover, it is understood that one or more blocks shown may be completed in a different order or may be performed simultaneously. For example, block 208 and block 210, as described herein, may be performed simultaneously.

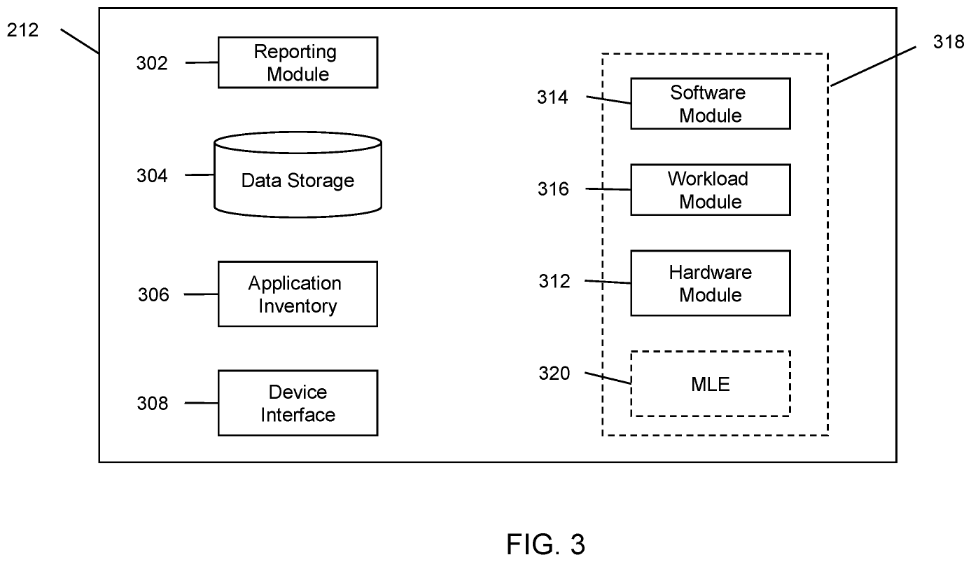

At block 208, the application or change to the application proposed is at least in part parameterized. For example, the application can be parameterized to specify simulation models, such as a software model of the functionality of the application (e.g., software model 314 of FIG. 3), and simulation criteria, such as load profiles and required levels of operations (e.g., as defined by a contract, or other instrument imposing operational requirements), and dependencies upon which the application relies. These parameters may be stored in an application inventory (e.g., application inventory 306 of FIG. 3).

At block 210, resources required for the performance testing may be scheduled. In example embodiments, the resources can include computing resources (e.g., certain computing resources 8, for a certain duration), personnel resources (e.g., test planning personnel), and so forth. The resulting schedule can be stored and updated periodically, so that all users associated with the configuration are kept informed of developments in the schedule.

Similarly, at block 210, resources required to perform the simulation can be scheduled. In example embodiments, certain users having the second user account type 204 may have access to various simulation configurations, such that they can access scheduling information related to a plurality of simulations.

At block 212, a simulation of the application can be conducted by a simulation module (hereinafter, the reference numeral 212 shall interchangeably refer to a simulation module 212 which simulates the application).

Referring now to FIG. 3, a block diagram of an example configuration of a simulation module 212 is shown.

In at least some example embodiments, the simulation module 212 is hosted within the enterprise system 6, and can include a reporting module 302, a database 304, an application inventory 306, and a device interface 308.

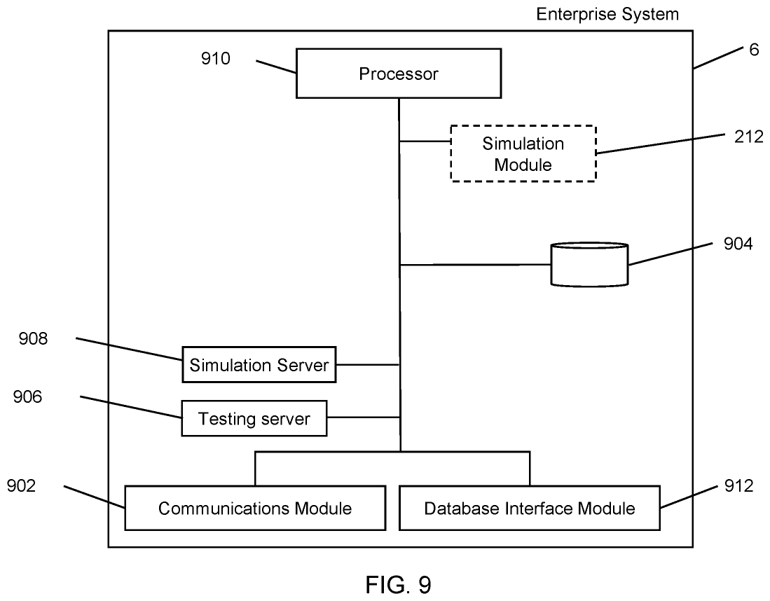

The device interface 308 facilitates communication with the device 4. In at least some example embodiments, the device interface 308 includes various application programming interfaces (APIs) to facilitate communication with the device 4 via various channels. For example, the device interface 308 can allow for the device 4 to access the enterprise system 6 via a web browser application (e.g., see, web browser application 914 in FIG. 9).

The application inventory 306 includes, as alluded to in respect of FIG. 2, parameters of one or more applications, and/or the applications themselves, and/or models of the applications. In at least one example embodiment, the application inventory also stores parameters associated with analyzing simulation results for each application in the application inventory 306 (hereinafter referred to as simulation evaluation parameters). For example, the application inventory 306 can store a web application and related parameters including parameters defining one or more of an application identifier (e.g., application name, build number, etc.), related application models (e.g., the aforementioned code analysis based model), a sponsor line of business (LOB), an application category identifier (e.g., a web application, a web service API, etc.), one or more simulation evaluation parameters (e.g., criteria derived from a service level agreement, a baseline, a previous testing history, etc.), one or more simulation parameters (e.g. performance assets such as load profile data, load test scripts, data creation scripts, application specific knowledge, names associated with test types, transaction names, and/or details of the infrastructure for various environments to be used in the simulation, etc.). The simulation parameters can include parameters mapping an application's relationships to its end-users and to dependent software.

In example embodiments, the application inventory 306 serves as a repository for all applications that have gone through the assessment described in block 206 and can be accessed by the device 4 to generate a graphical user interface (GUI) to display historical information. The GUI can display, for example: a history of previous engagements (e.g., simulations) connected to a particular application, all previous reports analyzing simulation results, an overview of the consumers/dependencies for the application, and links to previously built assets such as scripts, data creation scripts, etc.

The database 304 can store data, tools, applications, etc., required for performing and analyzing simulations. For example, the database 304 can store the application inventory 306. In example embodiments, the database 304 stores the raw simulation results. In other example embodiments, the database 304 stores the parameters or other data used for simulations, simulation results, simulation analysis reports, etc. In at least some example embodiments, the database 304 is either in part or in whole stored on the external computing resources 8.

The reporting module 302 includes one or more parameters for generating notifications based on the simulation results generated by the simulation module 212. For example, the reporting module parameters can define a format of the notification (e.g., email, SMS message, etc.), the content of the notification (e.g., an indication of whether certain criteria are met, which simulations were performed, etc.), timing associated with the notification, which individuals should be notified of the analysis results (e.g., project management personnel, simulation personnel, etc.), and so forth.

The simulation module 212 executes simulations to output data reflecting the performance of the application, before or otherwise preliminary to or without performing a performance test. The simulation module 212 includes a hardware model 312, a software model 314, and a workload model 316.

The hardware model 312 can be a variable model, in that parameters that define the model may be adjusted irrespective of whether there have been changes to the application. For example, the hardware model 312 can be varied to simulate how the application will behave in environments having different hardware configurations. For example, the hardware model 312 can be intentionally, possibly iteratively, updated to execute simulations on a plurality of plausible hardware configurations. In example embodiments, the hardware model 312 can be periodically updated to reflect the expected resources (e.g., computing resources 8) as application development or application testing progresses.

In at least some contemplated embodiments, the variability of the hardware model 312 refers to the ability of parameters of the model to be adjusted by the simulation process. For example, the hardware model 312 can be one component of a larger machine learning model for simulating performance of an application under testing, wherein the machine learning process necessitates adjusting values for parameters, including the hardware model 312, via an iterative process.

The hardware model 312 can be defined by one or more parameters representative of, for example, a number of nodes in a cluster, cores per host, thread pools, etc. The hardware model 312 can model existing or expected hardware configurations. For example, the hardware model 312 can defined at least in part by an expected cost to implement the hardware configuration denoted by the hardware model 312 on computing resources 8 (e.g., this service should not require more than X dollars for cloud computing costs).

In at least some contemplated embodiments, the hardware model 312 can include a plurality of hardware models, such one or more scenario models, one or more hardware component models, etc. For example, the hardware model 312 can include a scenario model that defines a typical hardware infrastructure for a mobile application, or other expected scenarios, etc. The hardware model 312 can be comprised of an assembly of component models describing each component individually. For example, the hardware model 312 can be an amalgamation of various processor, database, communication hardware and memory models.

The software model 314 includes one or more parameters intended to define the operation of the proposed application. In at least some example embodiments, the software model 314 is generated at least in part by code profiling, for example. Code profiling, generally, includes analyzing the impact of the software model 314 on physical computing infrastructure (e.g., the memory, the processor, any network hardware, etc.), and can include assessing the impact on a per component basis of the software model 314 (e.g., assessing the impact of each particular method or routine of the software model 314). In example embodiments, code profiling can include sampling profilers, instrumenting profilers, etc. Particularizing the example, the software model 314 can be generated by code profiling via a third-party performance profiling tool (e.g., based on a Dynatrace profile), with different parts of the profile being assigned as a parameter. In some example embodiments, for example, the software model 314 can be generated by the following process:

A preliminary model of the application can be constructed. For example, rudimentary functionality can be implemented that responds to a main anticipated function for the application. In example embodiments, the preliminary model is generated by assembling certain pre-existing code modules, such as certain existing methods, to perform the main anticipated function of the application.

In some example embodiments, the preliminary model is generated based on one or more anticipated scenarios. For example, where the application in issue is expected to be used in a scenario where it interacts with internal and external resources, and the most damaging failure is anticipated to be unauthorized access, the preliminary model can be developed to an extent to enable testing of validation processes to ensure protection of the internal information.

The preliminary model can be used to generate one or more results. For example, the preliminary model can be used for the main anticipated functionality in a synthetic environment, with synthetic data as required. The environment used to generate results (synthetic or otherwise) can be a scaled down environment, such as a dedicated development environment to ensure that the preliminary model cannot impact production.

Thereafter, the results of the preliminary model operations can be ingested by a code profiling tool (e.g., the third-party performance profiling tool) to generate a software model 314. In at least some example embodiments, the results of the preliminary model are formatted prior to being provided for generating the software model 314. For example, the results can be formatted to comply with requirements of a third-party profiling tool.

In at least some example embodiments, results are not generated by the preliminary model, and the code profiling tool generates the software model 314 without operation.

In at least some contemplated embodiments, the software model 314 is relatively fixed compared to the hardware model 312 and the workload model 316. That is, the parameters of the software model 314 are not adjusted, after their determination, by the simulation process. For example, the software model 314 can be one component of a larger machine learning model for simulating performance of an application under testing, wherein the machine learning process necessitates adjusting values for parameters, other than the parameters of the software model 314, via an iterative process. In example embodiments, the parameters of the software model 314 are unchanged, but the machine learning process may adjust a weight assigned to the parameters of the software model 314 to adjust the relative importance of the different parameters in the overall process.

The software model 314 can also be updated periodically to reflect the latest build. For example, when the application change is reflected in the latest build of the application, such build can be used to generate the software model 314 as described herein.

The workload model 316 defines a desired load profile for the simulation. For example, the workload model 316 can include parameters defining the distribution (e.g., temporally, or with respect to physical resources) and amount of workload (e.g., the number of transactions) to define the environment of the application during simulation. The workload model 316 can include parameters representative of the anticipated typical peak and average cases to increase the particularity of the workload model 316.

The workload model 316 can be a variable model, in that parameters that define the model may be adjusted irrespective of whether there have been changes to the application and surrounding circumstances(e.g., less workflow observed). For example, the workload model 316 can be varied to simulate the application under different load conditions. In example embodiments, the workload model 316 can be periodically updated to reflect the expected loading (e.g., the applications scope may broaden or narrow) as application development or application testing progresses.

Collectively, the hardware model 312, the software model 314, and the workload model 316 can be used to at least in part define a performance model 318. The performance model 318 can include parameters representative of factors other than the aforementioned models. For example, the performance model 318 can include parameters that adjust the output of performance models 318 based on past experiences implementing performance models. Further particularizing the example, the performance model 318 can include one or more parameters to elevate the importance of one of the hardware model 312, the software model 314, and the workload model 316 at the expense of the other models, as a particular model may be found to be more accurate in predicting application performance.

Similar to the hardware model 312 and the workload model 316, the performance model 318 can be varied. In at least some contemplated embodiments, the performance model 318 is updated to reflect changes in either the hardware model 312 or the workload model 316. In some example embodiments, for example, the parameters other than the parameters of the component models are updated as testing progresses. For example, the performance model 318 can adjust parameters as testing progresses to reflect that the application being simulated is more developed, and the workload model 316 is more likely to be accurate.

The performance model 318 can be a model refined or otherwise generated through a machine learning process, for example via a machine learning engine (MLE) 38. The MLE 38 may perform operations that classify the described models, or model parameters, or model outcomes or outputs (collectively hereinafter referred to generally as model information) with corresponding classifications parameters, e.g., based on an application of one or more machine learning algorithms to each of the models. The machine learning algorithms may include, but are not limited to, a one-dimensional, convolutional neural network model (as described herein), and the one or more machine learning algorithms may be trained against, and adaptively improved using, elements of previously classified models identifying instances where previous performance models 318 were accurate or within an acceptable range. Subsequent to classifying the model information, the MLE 38 may further process each element of the model information to identify, and extract, a value characterizing the corresponding one of the classification parameters, e.g., based on an application of one or more additional machine learning algorithms to each of the elements. By way of the example, the additional machine learning algorithms may include, but are not limited to, an long short term memory (LSTM) that, among other things, attempts to control the so called memory of the process to elevate the importance of certain candidate parameter values relative to one another (e.g., the 10^{th} simulated workload may be more important than the first simulated workload). The one or more additional machine learning algorithms may be trained against, and adaptively improved using, historical data. Classification parameters may be stored and maintained, and training data may be stored and maintained.

Examples of these adaptive, machine learning processes include, but are not limited to, one or more artificial, neural network models, such as a one-dimensional, convolutional neural network model, e.g., implemented using a corresponding neural network library, such as Keras®. In some instances, the one-dimensional, convolutional neural network model may implement one or more classifier functions or processes, such a Softmax® classifier, capable of predicting an association between an element of the model information (e.g., a parameter representing software complexity) and a single classification parameter (e.g., an indication that the performance model will fail) and additionally, or alternatively, multiple classification parameters.

The outputs of the machine learning algorithms or processes may then be used by the performance model 318 to output an expected outcome (e.g., pass/fail), an error range, confidence level, or other parameter denoting the uncertainty in the outcome, the reason that the application is predicted to fail, and so forth.

The performance model 318 can be trained to suggest remedial action if the expected outcome is a failure. For example, the performance model 318 can be configured to suggest that functionalities of the application which account, to the greatest extent, for the failure, be reconsidered.

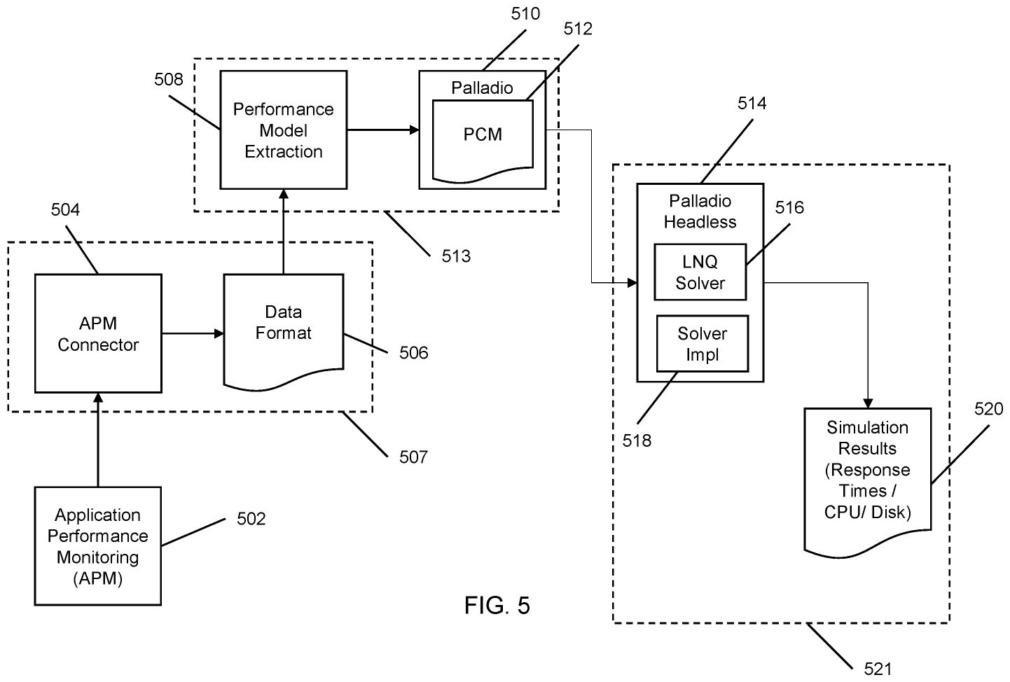

In at least some example embodiments, the performance model 318 may not be a model based on machine learning processes and can be any performance model 318 that is solvable by the solver designated to implement the simulation (e.g., see LINQ solver 516 of FIG. 5).

In at least some example embodiments, the performance model 318 and the application inventory 306 interact with one another, such that changes to the application inventory 306 can trigger changes to the performance model 318. For example, where new expected workloads for testing the application in issue are loaded to the application inventory 306, the workload model 316 of the performance model 318 can be updated to reflect the new workload.

In at least some example embodiments, the performance model 318 or components thereof can be imported for the simulation of another application. For example, where two applications include similar functions (e.g., one application for Android™ phones, and another for phones operating the iOS™), the performance model 318 for one can be re-used or incorporated in part into the other.

The simulation module 212 therefore facilitates potentially faster, less expensive, more robust, or more accurate evaluations of whether an application's performance is likely to be successful. The simulation module 212 can be used to simulate a variety of applications (e.g., by employing different software models 314). Moreover, the performance model 318 or components thereof can provide an efficient, fast, and consistent means for simulating applications. For example, test planning personnel may create modular pre-configured workload and hardware models, as can test execution personnel. These models can be used as a standard for a certain point in time, and reflect the most common use case scenarios, allowing developers to quickly incorporate simulations into their testing regimes. Moreover, the simulation module 212 can facilitate the exchange of knowledge derived from previous tests, and the organizational consistency embodied by the components of the simulation module 212 (e.g., the software model 314 can be generated consistently with a particular third-party provider) can facilitate leveraging existing simulation best practice into application simulation. For example, a certain third-party code profiling providers may be identified as having relatively accurate models in respect of a first type of application, whereas other third-party code profiling providers can have relatively accurate models in respect of a second type of application.

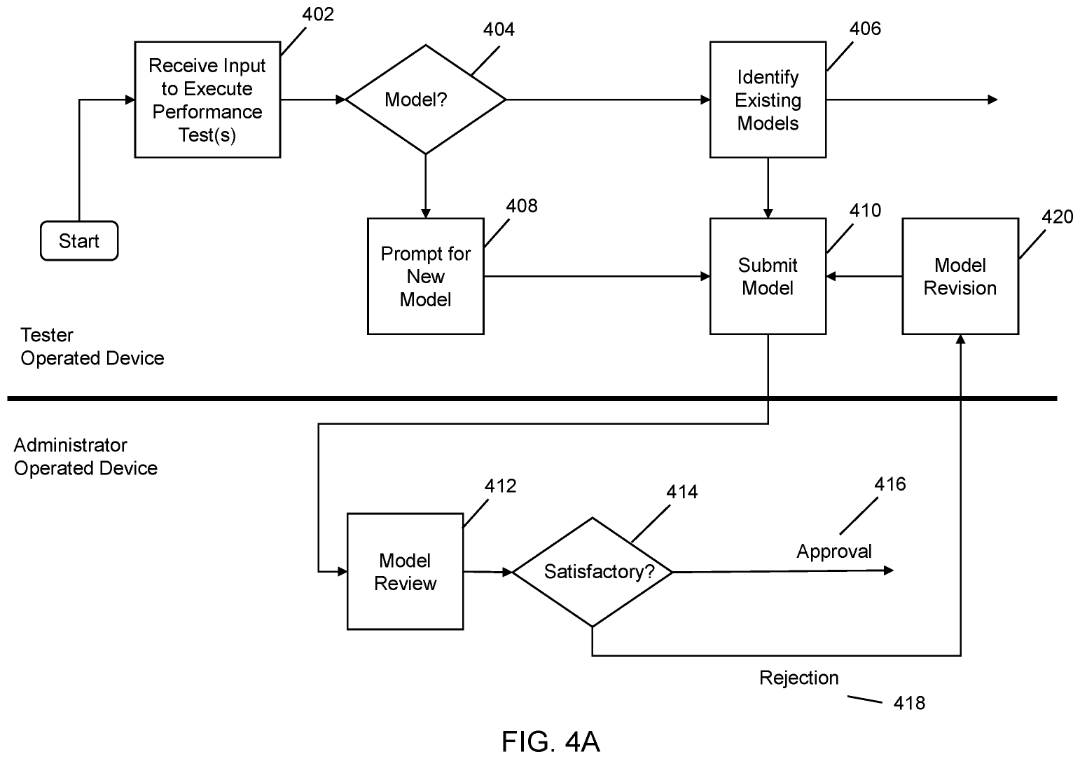

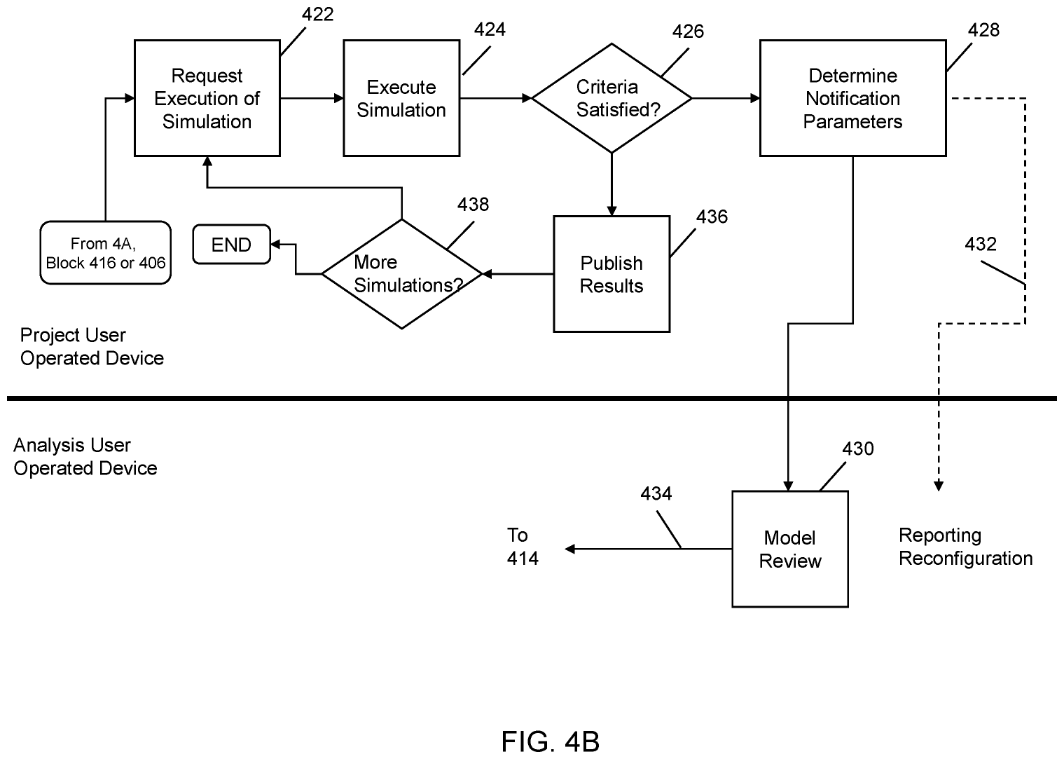

Referring now to FIG. 4A, a flow diagram of an example of computer executable instructions for generating a performance model 318 is shown. In FIG. 4A, it is contemplated, and shown, that two separate users (e.g., different users, each with a different device 4) are responsible for interacting with a performance model 318: an administrator operated device (bottom of the figure), and a tester operated device (top of the figure). The delineation between user actions is illustrative only and is not intended to be limiting.

At block 402, an input associated with executing a performance test of an application is received. For example, the tester operated device may enter input into an application (e.g., a dashboard GUI for automated testing and automated testing analysis) to execute a performance test. In example embodiments, the input may be from a micro-service which monitors application development milestones which is coupled to the enterprise system 6 to automate testing.

At block 404, a performance model 318 or component thereto is input, located or selected. In embodiments where a performance model 318 is input or located, the input can be provided via a graphical user interface (GUI), which can include a listing of available performance model 318 or components thereof, and provide for the selection of the tool to create new performance model 318 or component thereof.

At block 406, where the input is indicative of an existing performance model (e.g., where the performance model 318 has had a component updated and is being re-run with at least some new parameters), the simulation may be executed, and the simulation results may thereafter be analyzed as described herein.

At block 408, where the input is not indicative of an existing performance model 318 (e.g., a tool to create a new performance model 318 is selected), a prompt or other mechanism to create a new performance model 318 can be generated, such as a GUI. In example embodiments, the GUI can include one or more components to standardize and simplify the process of generating a simulation. For example, the prompt can include a checklist allowing selection of one or more features of the simulation (e.g., the standardized components discussed herein, or selection of which third party provider to use to generate the software model 314, etc.) and various other fields for customizing the simulation. The checklist may allow configuration of the performance model 318 based on an expected type of performance test, based on an expected recipient list, etc. In example embodiments, the prompt may show existing performance models 318 from similar applications.

At block 410, the generated performance model 318 can be submitted to an administrator operated device for review and approval. In at least some example embodiments, all performance models 318, including existing performance models 318 in block 406, are required to be submitted again for approval prior to their use.

In at least some example embodiments, the block 410 denotes the submission of individual components of the performance model 318 for review. For example, the workload model 316 can be submitted for review separate from the performance model 318. The framework can also provide that the specific model submitted is required to be reviewed by a specific type of reviewer. For example, the workload model 316 review can be required to be submitted to a user from a business forecasting team, in contrast to, for example, the hardware model 312 being submitted to an infrastructure management team member.

At block 412, the performance model 318 is reviewed by the administrator operated device. The review can include, for example, a review of whether the performance model 318 includes realistic or appropriate hardware models 316. In at least some example embodiments, the review is automated, and, for example, reviews whether the necessary resources have been scheduled or are available, or whether access protocols have been respected, etc.

At block 414, the administrator operated device either approves or rejects the performance model 318.

If approved, the performance model 318 is transmitted pursuant to block 416 to implement the simulation.

If the performance model 318 is rejected, pursuant to block 418, the performance model 318 may be sent back to the tester operated device for revision at block 420.

Referring now to FIG. 4B, a flow diagram of an example of computer executable instructions for analyzing simulation results is shown. As with FIG. 4A, it is contemplated, and shown in FIG. 4B, that two separate users (e.g., users of different devices 4) can interact with the process for analyzing simulation results: an administrator operated device (bottom of the figure), and a tester operated device (top of the figure). The delineation between user actions is illustrative only and is not intended to be limiting. Furthermore, it is understood that the entire process may be automated based on preconfigured parameters, without input from device 4.

At block 422, a request is sent to perform a simulation with a performance model 318. In example embodiments, the simulation may be conducted within the enterprise system 6, or the simulation may be conducted on the computing resources 8, or some combination thereof.

At block 424, the simulation is executed. In at least some example embodiments, multiple simulations can be run simultaneously or in sequence. For example, multiple simulations with performance models 318 that are different solely in respect of their hardware models 312 can be executed to determine the impact of the modelled hardware configuration on the application performance.

At block 426, the simulation results are compared to one or more simulation evaluation parameters to determine whether the simulation indicates that the application is likely to operate successfully, or operate within an acceptable range, etc.

In at least some example embodiments, the simulation evaluation parameters are used to determine whether the simulation provides meaningful results. For example, where the simulation results indicate that the simulation failed to properly initialize, a parameter can indicate that problems associated with the simulation should be explored, and that the results are not indicative of a potential success of the application performance test.

Some example embodiments, for example, include simulation evaluation parameters that are at least in part related to the application inventory 306 and performance expectations set out therein. For example, the application inventory 306 can store an acceptable likelihood of success (e.g., 60% likelihood) which may be updated (e.g., the acceptable likelihood of success can be increased as further resources are invested in the application), and the acceptable likelihood of success can be a parameter incorporated into the simulation evaluation parameters. Where the simulation results comply with the simulation evaluation parameters, the simulation results may be consumed by one or both of block 428 and block 436.

Where simulation results do not satisfy the simulation evaluation parameters, that can be an indicator that the application (or particular build thereof) being submitted for simulation is unsatisfactory and require the development team to revise the application used to generate the software model 314.

At block 428, the simulation results can be processed by the reporting module 302, to facilitate transmission to one or more analysis user operated devices. For example, in a continual review cycle, analysis users may wish to periodically review or be notified of successful simulations of application to adjust scheduling or resource allocation. In some embodiments, for example, the performance model 318 is also continually reviewed upon the completion of a simulation to ensure correct operation or to determine improvements. This is shown by block 430, analogous to block 412, where additional model review is undertaken.

At block 432, the simulation results may trigger a reconfiguration or specific triggering of certain reporting parameters. For example, upon completion of some scheduled simulation, interim reports may be generated and provided only to a limited number of reviewers. In contrast, upon completion of all scheduled simulation, different notification parameters may be employed to notify personnel at higher levels of the project.

At block 434, based on the simulation results, the analysis user may request to modify the performance model 318 and have the proposed modifications reviewed pursuant to block 414 (e.g., by a different user, or the same user may be required to certify that the changes comply with existing template criteria, etc.).

The block 436, the simulation results are published for all project user operated devices. In this way, project users may be able to access simulation results immediately upon their satisfaction of certain criteria.

At block 438, it is determined whether additional simulations are scheduled (e.g., another simulation with different hardware parameters 312 scheduled). If additional simulation is scheduled, additional simulation can be performed as described herein.

FIGS. 4A and 4B are illustrative, and not intended to limit the scope of the pending application to the method described therein. FIG. 5, for example, shows a block diagram of another example of computer executable instructions for generating at least a component of a performance model used by a simulation module. In example embodiments, at least some of the steps of FIG. 5 are incorporated into the method outlined in FIGS. 4A and 4B.

At block 502, an application performance monitoring (APM) tool collects and profiles APM data to develop the software model 314.

At block 506, data collected in block 502, and the input to or output from the resulting software model 314, is formatted to facilitate processing outputs of other applications or tools (i.e., inputs to software model 314), or to facilitate processing by other applications of the data or output of the software model 314. In example embodiments, the formatted data of block 506 is generated by an APM connector 504 that formats the data.

Blocks 504 and 506 may be part of a single data formatting module 507.

At block 508 the remaining components of the performance model 318 are extracted (e.g., from the application inventory 306, etc.), and at least in part compliant with or able to communicate on the basis of the format of block 506.

At block 510, an architectural modelling tool (e.g., in the shown embodiment the Palladio™ tool) is used to specify one or more parameters of the hardware model 312. For example, the tool may include models of individual hardware components, and generate parameters relevant to individual components that are anticipated to comprise the hardware configuration to define the hardware model 312.

Blocks 508 and 510 may be part of a single automated generation module 513.

At block 514, the performance model 318 can be executed to run a simulation. In example embodiments, execution of the performance model includes an implementation of a Language Integrated Query(LINQ) solver 516, or another solver implementation 518, etc. The solver selected can be responsive to the expected simulation results, to allow for comparison with certain simulation evaluation parameters.

At block 520, the simulation results are generated. The simulation results can include, for example, response times, CPU/Disk performance, etc.

Blocks 514 and 520 may be part of a single automated simulation module 521.

In example embodiments, the simulation results can trigger the assigning of one or more resources (e.g., the application will not be successful with the proposed hardware model 312, and so additional resources need to be assigned to the application), or the results can trigger a removal of resources (e.g., the proposed application is not close to a satisfactory performance level, resulting in delayed testing as a result of poor simulation results, etc.).

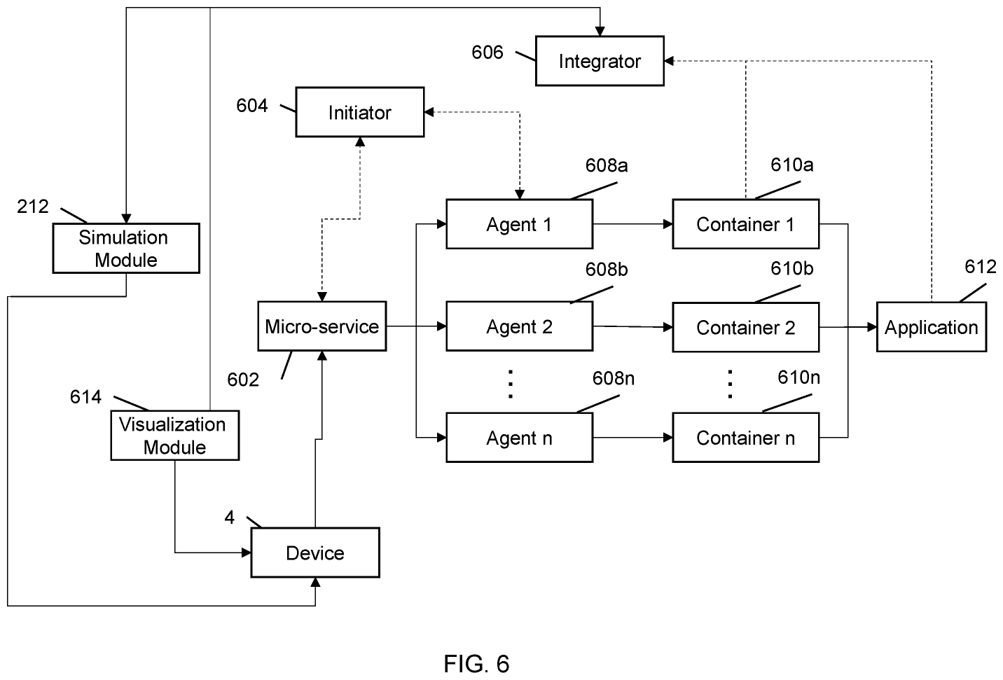

The simulation results can be used to determine whether a larger framework for automated testing is implemented. For example, where the outcome of the simulation satisfies one or more simulation evaluation criteria (e.g., the application is likely to be stable in a production environment similar to the component models), the process of implementing a performance test can proceed (e.g., block 214 of FIG. 2), or further development of the application or application change can proceed. For example, referring now to FIG. 6, a schematic diagram of an example framework for automated testing is shown.

A micro-service 602 can receive a request to initiate testing from a device 4. In example embodiments, the micro-service 602 can receive or monitors the device 4 to determine whether to begin testing (e.g., the micro-service 602 integrates with a scheduling application on the device 4).

In response to receiving the request, the micro-service 602 can initiate one or more agents 608 (shown as including a plurality of agents 608a, 608b . . . 608n) to implement the requested testing. Each agent 608 can, in at least some example embodiments, initiate or schedule a container 610 (shown as containers 610a, 610b . . . 610n, corresponding to the agents 608) to implement the testing. The container 610 can be, for example, a computing environment with dedicated hardware computing resources 8 to implement the testing.

In at least some contemplated embodiments, the micro-service 602 initiates multiple agents 608 to run testing in parallel. For example, the micro-service 602 can initiate different agents 608 to run a separate test on simulations of different popular cellphones (e.g., test simulations of Android™ and iOS™ phones in parallel).

The micro-service 602 can initiate an agent 608 via an initiator 604. For example, certain architectures can require a separate initiator 604 to initiate agents 608 for security purposes, where the micro-service 602 must authenticate or otherwise satisfy security credentials of the initiator 604.

Each container 610 can thereafter be used to test the application 612. In example embodiments, each container tests different instances of the application 216, to enable the aforementioned parallel testing.

A visualization module 614 enables a device 4 to view information about the testing. For example, the visualization module 614 can be in communication with the micro-service 602 to see which tests have been initiated by the micro-service 602, and information related thereto (e.g., test x has been received by the micro-service 602, an agent 608 or container 610 has been successfully initiated or is missing certain inputs, etc.).

The disclosed framework can also enable automated provisioning of simulation results to the visualization module 614 (e.g., via the integrator 606).

Referring again to FIG. 2, results of the executed performance testing at block 214 are thereafter provided to the analysis module 216.

The analysis module 216 consumes the test results to generate the analysis results(i.e., analysis of the test results of an implemented performance test). The analysis and test results can be formatted for reporting as a performance analysis report.

The visualization module 218, which may be incorporated within the visualization module 614 (FIG. 6) can consume test results, analysis results, or simulation results from the simulation module 212 to generate one or more visualizations. In example embodiments, the visualization module 218 generates a dashboard allowing for review of analysis results, test results, and simulation results associated with more than one application or project engagement.

One example of a visualization that can be generated by the visualization module 218 is an interim email report. The report can include the raw simulation results of some, or all simulations associated with a particular application e (and potentially allow for reviewing simulations of a variety of applications via a toggling feature). The report can provide data in various formats (e.g., excel friendly formats, word friendly formats, etc.).

The visualizations can also be generated based on one or more templates, which can specify a field such as the number of simulations passed, the runtime of the simulation, the date of the simulation, etc.

The improvement module 220 can be used to provide feedback and adjust the simulation process. For example, actual results from real world usage of similar applications can be leveraged to adjust subsequent performance models 318 generated or stored by the simulation module 212, or the simulation evaluation parameters stored therein, such that more meaningful evaluation criteria are developed.

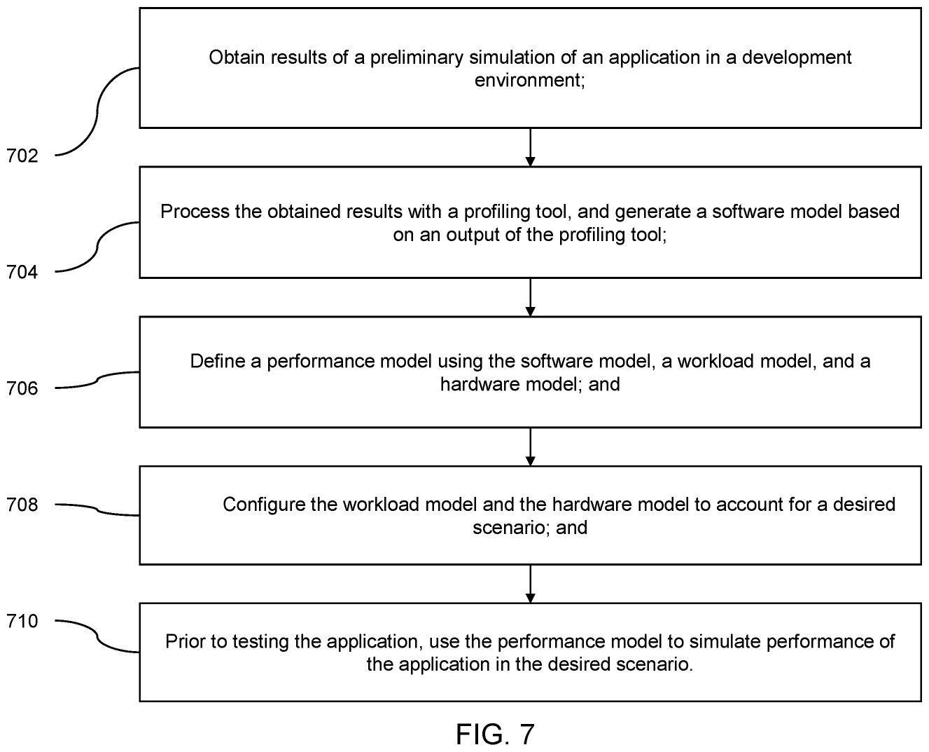

Referring now to FIG. 7, a flow diagram of yet another example of computer executable instructions for simulating application performance without conducting performance testing.

At block 702, results of a preliminary simulation of an application in a development environment are obtained. The preliminary simulation may be conducted using the preliminary model discussed herein. The development environment may be a simplified or lower computing environment. The preliminary simulation can be initiated in response to receiving a determination that the application requires simulation (e.g., simulation is required as the proposed application is expected to impact critical infrastructure, or where enough additional or existing applications are impacted by the proposed application).

At block 704, the obtained results are processed with a software profiling tool and a software model is generated based on an output of the software profiling tool.

At block 706 a performance model is defined using the software model, a workload model, and a hardware model.

At block 708, the workload model and the hardware model are configured to account for a desired scenario.

At block 710, prior to testing the application, the performance model is used to simulate performance of the application in the desired scenario.

It is understood that the process is not limited to the sequence shown in FIG. 7, and that variations to the block sequence shown in FIG. 7 are contemplated. For example, blocks 706 and 708 may occur simultaneously, or in reverse order. In another example, block 708 may occur before the software model is generated or defined.

The example method described in FIG. 7 can be a fully automated process. For example, the performance model 318 may be generated automatically upon detection of a new build of an application being added to the application inventory 306. In example embodiments, the simulations are automatically run periodically to assess application development.

In FIG. 8, an example configuration of the device 4 is shown. In certain embodiments, the device 4 may include one or more processors 802, a communications module 804, and a data store 806 storing device data 808 and application data 810. Communications module 804 enables the device 4 to communicate with one or more other components of the computing environment 2, such as the enterprise system 6, via a bus or other communication network, such as the communication network 10. While not delineated in FIG. 8, the device 4 includes at least one memory or memory device that can include a tangible and non-transitory computer-readable medium having stored therein computer programs, sets of instructions, code, or data to be executed by processor 802. FIG. 8 illustrates examples of modules and applications stored in memory on the device 4 and operated by the processor 802. It can be appreciated that any of the modules and applications shown in FIG. 8 may also be hosted externally and be available to the device 4, e.g., via the communications module 804.

In the example embodiment shown in FIG. 8, the device 4 includes a display module 812 for rendering GUIs and other visual outputs on a display device such as a display screen, and an input module 814 for processing user or other inputs received at the device 4, e.g., via a touchscreen, input button, transceiver, microphone, keyboard, etc. The device 4 may also include an enterprise application 816 provided by the enterprise system 6, e.g., for accessing data stored within the enterprise system 6, for the purposes of authenticating to gain access to the enterprise system 6, etc. The device 4 in this example embodiment also includes a web browser application 818 for accessing Internet-based content, e.g., via a mobile or traditional website. The data store 806 may be used to store device data 808, such as, but not limited to, an IP address or a MAC address that uniquely identifies device 4 within environment 6. The data store 806 may also be used to store application data 810, such as, but not limited to, login credentials, user preferences, cryptographic data (e.g., cryptographic keys), etc., or data related to application testing. The device 4 can include an instance of the simulation module 212, as described herein.

In FIG. 9, an example configuration of an enterprise system 6 is shown. The enterprise system 6 includes may include one or more processors 910, a communications module 902 that enables the enterprise system 6 to communicate with one or more other components of the computing environment 2, such as the device 4, via a bus or other communication network, such as the communication network 10. While not delineated in FIG. 9, the enterprise system 6 includes at least one memory or memory device that can include a tangible and non-transitory computer-readable medium having stored therein computer programs, sets of instructions, code, or data to be executed by one or more processors (not shown for clarity of illustration). FIG. 9 illustrates examples of servers and datastores/databases operable within the enterprise system 6. It can be appreciated that servers shown in FIG. 9 can correspond to an actual device or represent a simulation of such a server device. It can be appreciated that any of the components shown in FIG. 9 may also be hosted externally and be available to the enterprise system 6, e.g., via the communications module 902. In the example embodiment shown in FIG. 9, the enterprise system 6 includes one or more servers to provide access to data 2004, e.g., to implement or generate the simulations described herein. Exemplary servers include a testing server 906, a simulation server 908 (e.g., hosting simulation module 212, or the simulation module 212 can be hosted other than on a dedicated server within the enterprise system 6). Although not shown in FIG. 9, as noted above, the enterprise system 6 may also include a cryptographic server for performing cryptographic operations and providing cryptographic services. The cryptographic server can also be configured to communicate and operate with a cryptographic infrastructure. The system 6 can include an instance of the simulation module 212, as described herein.

The enterprise system 6 may also include one or more data storage elements for storing and providing data for use in such services, such as data storage 904. The data storage 904 can include, in an example embodiment, any data stored in database 304, or data received from a third party (e.g., code profiling data), etc. The enterprise system 6 can include a database interface module 912 for communicating with databases for the purposes of generating or interpreting simulation results. For example, a hardware model 312 can be stored remote to the enterprise system 6 (e.g., provided by a cloud computing service provider) and retrieved via the database interface module 912 or the communications module 902.

It will be appreciated that only certain modules, applications, tools and engines are shown in FIGS. 1-3, 8, and 9 for ease of illustration and various other components would be provided and utilized by the enterprise system 6, or device 4, as is known in the art.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of any of the servers or other devices in the enterprise system 6 or the device 4, or accessible or connectable thereto. Any application or module herein described may be implemented using computer readable/executable instructions that may be stored or otherwise held by such computer readable media.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A device for simulating application performance prior to performance testing, the device comprising:
a processor;
a communications module coupled to the processor; and
a memory coupled to the processor, the memory storing computer executable instructions that when executed by the processor cause the processor to:
obtain results of a preliminary simulation of an application in a development environment;
process the obtained results from the preliminary simulation, with a profiling tool, and generate a software model based on an output of the profiling tool;
configure a workload model and a hardware model to account for a desired scenario;
define a performance model using the software model, the workload model, and the hardware model; and
prior to testing the application, use the performance model to simulate performance of the application in the desired scenario.

2. The device of claim 1, wherein computer executable instructions cause the processor to:
continuously update the performance model to account for changes in the workload model and the hardware model.

3. The device of claim 1, wherein computer executable instructions cause the processor to:
format the obtained results prior to generating the performance model.

4. The device of claim 1, wherein the profiling tool comprises a third-party software profiling tool.

5. The device of claim 1, wherein the workload model at least in part represents an expected peak and average workload of the desired scenario.

6. The device of claim 1, wherein the profiling tool models the application at least in part by code profiling.

7. The device of claim 1, wherein computer executable instructions cause the processor to:
initiate the preliminary simulation in response to determining the application requires simulation.

8. The device of claim 7, wherein computer executable instructions cause the processor to determine whether the application requires simulation by:
determining whether important applications are impacted by the application.

9. The device of claim 1, wherein computer executable instructions cause the processor to:
transmit results of the application simulation to a dashboard.

10. The device of claim 1, wherein computer executable instructions cause the processor to:
assign one or more resources in response to the results of the application simulation.

11. The device of claim 1, wherein the development environment comprises a scaled down development environment.

12. A method for simulating application performance prior to performance testing, the method comprising:
obtaining results of a preliminary simulation of an application in a development environment;
processing the obtained results from the preliminary simulation, with a profiling tool, and generating a software model based on an output of the profiling tool;
configuring a workload model and a hardware model to account for a desired scenario;
defining a performance model using the software model, the workload model, and the hardware model; and
prior to testing the application, using the performance model to simulate performance of the application in the desired scenario.

13. The method of claim 12, further comprising:
continuously updating the performance model to account for changes in the workload model and the hardware model.

14. The method of claim 12, further comprising:
formatting the obtained results prior to generating the performance model.

15. The method of claim 12, wherein the profiling tool comprises a third-party software profiling tool.

16. The method of claim 12, wherein the workload model at least in part represents an expected peak and average workload of the desired scenario.

17. The method of claim 12, wherein the profiling tool models the application at least in part by code profiling.

18. The method of claim 12, further comprising:
initiating the preliminary simulation in response to determining the application requires simulation.

19. The method of claim 12, further comprising:
assigning one or more resources in response to the results of the application simulation.

20. A non-transitory computer readable medium for simulating application performance prior to performance testing, the computer readable medium comprising computer executable instructions for:
obtaining results of a preliminary simulation of an application in a development environment;
processing the obtained results from the preliminary simulation, with a profiling tool, and generating a software model based on an output of the profiling tool;
configuring a workload model and a hardware model to account for a desired scenario;
defining a performance model using the software model, the workload model, and the hardware model; and
prior to testing the application, using the performance model to simulate performance of the application in the desired scenario.
